(19) United States
(12) Patent Application Publication
(10) Pub. No.: US 2020/0204074 A1
(43) Pub. Date: Jun. 25, 2020

(54) POWER SUPPLY CIRCUIT AND ELECTRIC VEHICLE

(71) Applicant: SONY CORPORATION, TOKYO (JP)

(72) Inventor: YOSHIKI OYAMA, KANAGAWA (JP)

(21) Appl. No.: 16/468,392

(22) PCT Filed: Nov. 13, 2017
(86) PCT No.: PCT/JP2017/040795

§ 371 Date: Jun. 11, 2019

(30) Foreign Application Priority Data
Dec. 21, 2016 (JP) 2016-247698

(51) Int. Cl. H02M 3/158; H02M 1/08

(52) U.S. Cl. CPC H02M 3/1582; B60K 6/46; H02M 1/08

(57) ABSTRACT

To enhance stability of an output from a power supply circuit. A power supply circuit includes: a switching element pair (10A, 10B) having a high-side switching element (Q1, Q3), and a low-side switching element (Q2, Q4) connected in series with the high-side switching element; and a control section (2) complementarily driving the respective switching elements configuring the switching element pair, in which the control section (2) controls ON/OFF of the respective switching elements in such a way that a switching duty of the high-side switching element and the low-side switching element in a first period of time (steady-state operation), and a switching duty of the high-side switching element and the low-side switching element in a second period of time (Q1 drive voltage maintaining operation) are different from each other.

### TECHNICAL FIELD

The present disclosure relates to a power supply circuit and an electric vehicle.

### BACKGROUND ART

Heretofore, a power supply circuit which can perform buck-boost operation has been proposed (e.g., refer to PTL 1).

### CITATION LIST

### Patent Literature

### [PTL 1]

Japanese Patent Laid-Open No. 2012-29361

### SUMMARY

### Technical Problem

In such a field, it is desired to enhance stability of an output from a power supply circuit.

Therefore, it is one of objects of the present disclosure to provide a power supply circuit and an electric vehicle in each of which stability of an output from a power supply circuit is enhanced.

### Solution to Problem

The present disclosure, for example, is a power supply circuit including: a switching element pair having a high-side switching element, and a low-side switching element connected in series with the high-side switching element; and a control section complementarily driving the respective switching elements configuring the switching element pair, in which the control section controls ON/OFF of the respective switching elements in such a way that a switching duty of the high-side switching element and the low-side switching element in a first period of time, and a switching duty of the high-side switching element and the low-side switching element in a second period of time are different from each other.

In addition, the present disclosure may be an electric vehicle including: a conversion device receiving supply of a power from a power supply system including the power supply circuit above described, and converting the power into a driving force of a vehicle; and a controller executing information processing related to vehicle control on a basis of information associated with a power storage device.

### Advantageous Effect of Invention

According to at least one embodiment of the present disclosure, the stability of the output from the power supply circuit can be enhanced. It should be noted that the effect described above here is not necessarily limited, and any of effects described in the present disclosure may be offered. In addition, the contents of the present disclosure are not interpreted in a limiting sense by the exemplified effect.

### BRIEF DESCRIPTION OF DRAWINGS

FIG. 1 is a circuit diagram depicting an example of a configuration of a power supply circuit according to an embodiment.

FIG. 2 is a timing chart for explaining that an output from the power supply circuit is fluctuated by a general step-up operation.

FIG. 3 is a timing chart for explaining that an output from the power supply circuit is fluctuated by a general step-down operation.

FIG. 4 is a timing chart for explaining the step-up operation of the power supply circuit according to the embodiment.

FIG. 5 is a timing chart for explaining the step-down operation of the power supply circuit according to the embodiment.

FIG. 6 is a block diagram for explaining an application example.

FIG. 7 is a block diagram for explaining another application example.

### DESCRIPTION OF EMBODIMENT

Hereinafter, an embodiment and the like of the present disclosure will be described with reference to drawings. It should be noted that the description is given in accordance with the following order.
<1. Embodiment>
<2. Modified Examples>
<3. Application Examples>

An embodiment and the like which will be described below are preferred concrete examples of the present disclosure, and the contents of the present disclosure are by no means limited to the embodiment and the like.

### Embodiment

### [1. Example of Configuration of Power Supply Circuit]

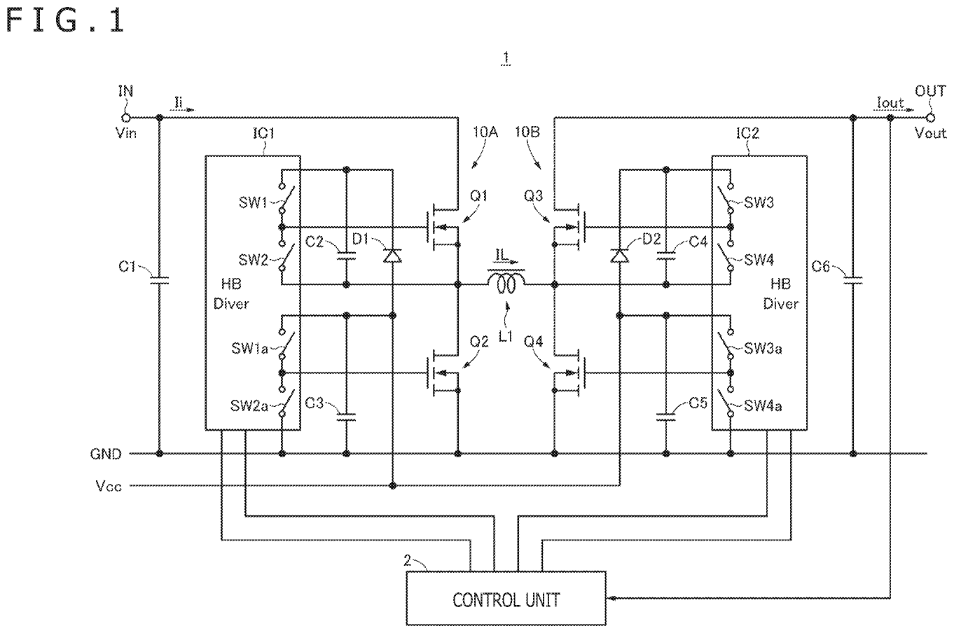

FIG. 1 is a circuit diagram depicting an example of a configuration of a power supply circuit (power supply circuit 1) according to an embodiment. The power supply circuit 1, for example, is a converter which can perform buck-boost operation of an input voltage. The power supply circuit 1 is schematically configured by coupling a half-bridge circuit 10A in which an N-channel MOSFET (Metal Oxide Semiconductor Field Effect Transistor) Q1 as an example of a switching element and a MOSFET Q2 are connected in series with each other, and a half-bridge circuit 10B in which a MOSFET Q3 and a MOSFET Q4 are connected in series with each other. A first switching element pair is configured by the MOSFETs Q1 and Q2, and a second switching element pair is configured by the MOSFETs Q3 and Q4.

An example of a configuration of the power supply circuit 1 is described in detail. Each of an input terminal IN and a ground GND is connected to the half-bridge circuit 10A. Specifically, the input terminal IN is connected to the MOSFET Q1 as the high-side switching element, and the ground GND is connected to the MOSFET Q2 as the low-side switching element. It should be noted that the high-side switching element means a switching element connected to a high-potential side, and the low-side switching element means a switching element connected to a low-potential side.

The input terminal IN is connected to a power supply not depicted, and an input voltage Vin is supplied from the power supply to the power supply circuit 1. The input voltage Vin, for example, is approximately 100 to 400 V. A capacitor C1 for stabilization is connected between the input terminal IN and the ground GND.

Each of an output terminal OUT and the ground GND is connected to the half-bridge circuit 10B. Specifically, the output terminal OUT is connected to the MOSFET Q3 as the high-side switching element, and the ground GND is connected to the MOSFET Q4 as the low-side switching element. A capacitor C6 and a load not depicted are connected to an output side of the half-bridge circuit 10B.

A connection midpoint between the MOSFET Q1 and the MOSFET Q2, and a connection midpoint between the MOSFET Q3 and the MOSFET Q4 are connected to each other via an inductor L1.

A half-bridge (HB) driver IC1 complementarily drives the MOSFET Q1 and the MOSFET Q2 in accordance with a control signal from a control unit 2. The wording complementarily drives means the driving which is performed in such a way that when one MOSFET is in an ON state, the other MOSFET is turned OFF. A switch SW1, a switch SW2 connected in series with the switch SW1, a switch SW1a, and a switch SW2a connected in series with the switch SW1a are provided within the half-bridge driver IC1. A connection midpoint between the switch SW1a and the switch SW2a is connected to a gate of the MOSFET Q2, the switch SW1a is connected to each of the connection midpoint of interest and one end side of the capacitor C3, and the switch SW2a is connected to each of the connection midpoint of interest and the ground GND. In addition, the half-bridge driver IC2 complementarily drives the MOSFET Q3 and the MOSFET Q4 in accordance with a control signal from the control unit 2. A switch SW3, a switch SW4 connected in series with the switch SW3, a switch SW3a, and a switch SW4a connected in series with the switch SW3a are provided within the half-bridge driver IC2. A connection midpoint between the switch SW3a and the switch SW4a is connected to a gate of the MOSFET Q4, the switch SW3a is connected to each of the connection midpoint of interest and one end side of a capacitor C5, and the switch SW4a is connected to each of the connection midpoint of interest and the ground GND.

A voltage Vcc is a power supply voltage for driving the MOSFETs Q1 to Q4, and the half-bridge drives IC1 and IC2 and, for example, is approximately 10 to a few tens of volts. For example, the voltage Vcc is supplied to the half-bridge drives IC1 and IC2 via the capacitors C3 and C5, respectively, and is used as a power supply for driving the MOSFETs Q2 and Q4.

A diode D1 and a capacitor (bootstrap capacitor) C2 are a bootstrap circuit (first bootstrap circuit) which generates a drive signal, stepped up to the input voltage Vin or more, for driving the MOSFET Q1. Each of a cathode of the diode D1, and one end side of the capacitor C2 is connected to the switch SW1 within the half-bridge driver IC1, and each of an anode of the diode D1 and the other end side of the capacitor C2 is connected to the switch SW2 within the half-bridge driver IC1. The switches SW1 and SW2 are complementarily driven, resulting in that the charging of the capacitor C2 by the voltage Vcc, and the application of the drive voltage (a voltage with a source reference) to the MOSFET Q1 are switched over to each other. (The input voltage Vin+the voltage Vcc) when viewed from the ground GND is applied to a gate of the MOSFET Q1.

A diode D2 and a capacitor (bootstrap capacitor) C4 are a bootstrap circuit (second bootstrap circuit) which generates a drive signal, stepped up to the input voltage Vin or more, for driving the MOSFET Q3. Each of a cathode of the diode D2, and one end side of the capacitor C4 is connected to the switch SW3 within the half-bridge driver IC2, and each of an anode of the diode D2 and the other end side of the capacitor C4 is connected to the switch SW4 within the half-bridge driver IC2. The switches SW3 and SW4 are complementarily driven, resulting in that the charging of the capacitor C4 by the voltage Vcc, and the application of the drive voltage (a voltage with a source reference) to the MOSFET Q3 are switched over to each other. (The input voltage Vin+the voltage Vcc) when viewed from the ground GND is applied to a gate of the MOSFET Q3.

The control unit 2 detects an output voltage Vout outputted from the output terminal OUT, and outputs a control signal which switches the MOSFETs Q1 to Q4 at suitable timings (switching duties), respectively, to the half-bridge drivers IC1 and IC2. The control unit 2, for example, includes a microcomputer, and calculates a period of time for which the MOSFETs are turned ON/OFF, or a length of a correction period of time which will be described later by performing a digital arithmetic operation. As an example, the control section is configured by the half-bridge drivers IC1 and IC2 and the control unit 2.

It should be noted that as depicted in FIG. 1, the power supply circuit 1 according to the embodiment has a configuration which is bilaterally symmetric, and is a bi-directional circuit (converter) which operates even in the case where the input side and the output side are reversed. For example, the batteries are respectively connected to the input side and the output side of the power supply circuit 1, and the charging and the discharging can be exchanged between the batteries via the power supply circuit 1.

### [Example of Operation of Power Supply Circuit]

Next, an example of a basic operation of the power supply circuit 1 is described. In the case where the input voltage Vin applied to the input terminal IN is stepped up to be outputted to the output terminal OUT, the half-bridge driver IC2 alternately turns ON/OFF the MOSFET Q3 and the MOSFET Q4. On the other hand, the half-bridge driver IC1 always holds the MOSFET Q1 in an ON state (always holds the MOSFET Q2 in an OFF state).

In the case where the input voltage Vin applied to the input terminal IN is stepped down to be outputted to the output terminal OUT, the half-bridge driver IC1 alternately turn ON/OFF the MOSFET Q1 and the MOSFET Q2. On the other hand, the half-bridge driver IC2 always holds the MOSFET Q3 in the ON state (always holds the MOSFET Q4 in the OFF state).

In such a manner, ideally, in the step-up operation, the MOSFET Q1 is always held in the ON state, thereby enabling the power supply circuit 1 to be operated as the step-up converter. However, when the MOSFET Q1 is continuously held in the ON state, the capacitance of the capacitor C2 is reduced. Then, the so-called bootstrap operation needs to be performed in which periodically, the MOSFET Q1 is turned OFF, and the MOSFET Q2 is turned ON, thereby supplying the voltage Vcc to the capacitor C2 via the diode D1 and the MOSFET Q2 to charge the capacitor C2. In the embodiment, although since the N-channel MOSFET is used as the MOSFET Q1, the voltage is applied to the gate when the MOSFET Q1 is turned ON, since a current is hardly caused to flow, the power with which the ON state of the MOSFET Q1 is maintained is very small. Therefore, the bootstrap operation has only to be performed at a long interval relative to the switching cycle, and a very short period of time can correspond to a period of time for which the MOSFET Q1 is held in the OFF state.

This also applies to the step-down operation. That is, ideally, in the step-down operation, the MOSFET Q3 is normally held in the ON state, thereby enabling the power supply circuit 1 to be operated as the step-down converter. However, when the MOSFET Q3 is continuously held in the ON state, the capacitance of the capacitor C4 is reduced. Then, the bootstrap operation needs to be performed in which periodically, the MOSFET Q3 is turned OFF, and the MOSFET Q4 is turned ON, thereby supplying the voltage Vcc to the capacitor C4 via the diode D2 and the MOSFET Q4 to charge the capacitor C4. In the embodiment, although since the N-channel MOSFET is used as the MOSFET Q3, the voltage is applied to the gate when the MOSFET Q3 is turned ON, since a current is hardly caused to flow, the power with which the ON state of the MOSFET Q3 is maintained is very small. Therefore, the bootstrap operation has only to be performed at a long interval relative to the switching cycle, and a very short period of time can correspond to a period of time for which the MOSFET Q3 is held in the OFF state.

### [With Respect to Fluctuation of Output Following Bootstrap Operation]

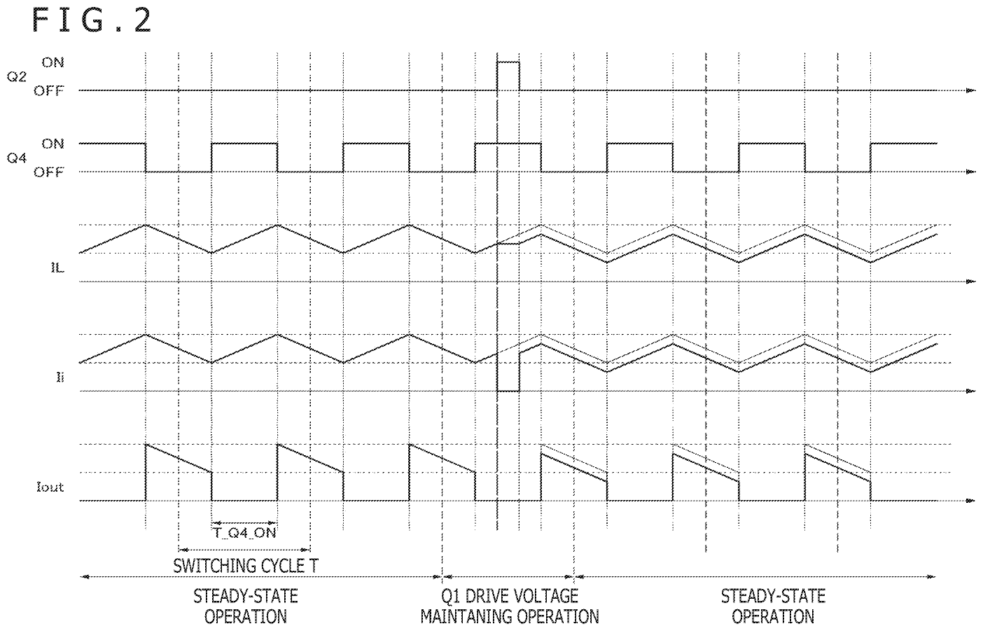

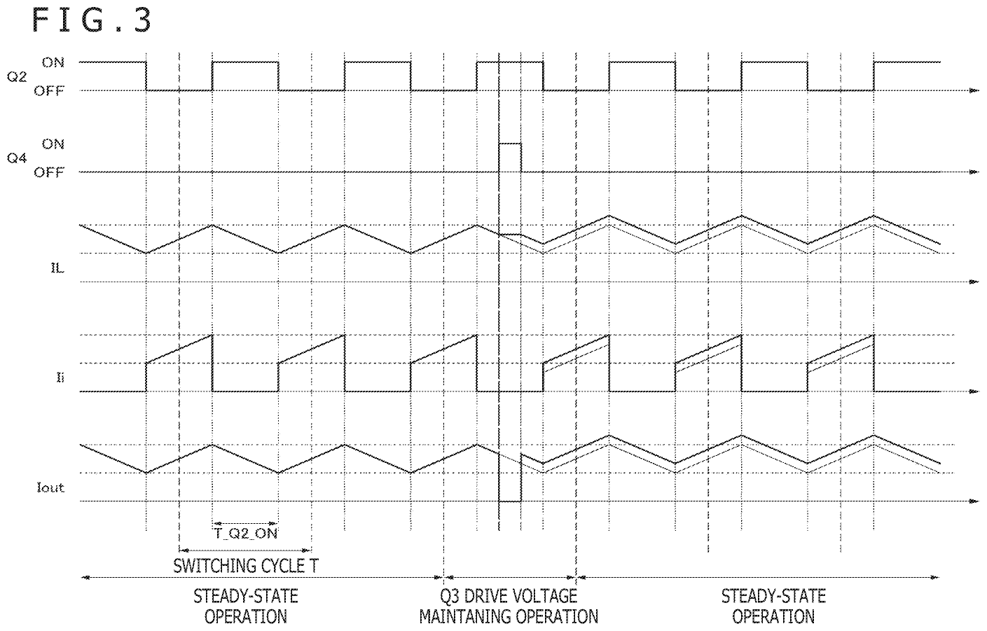

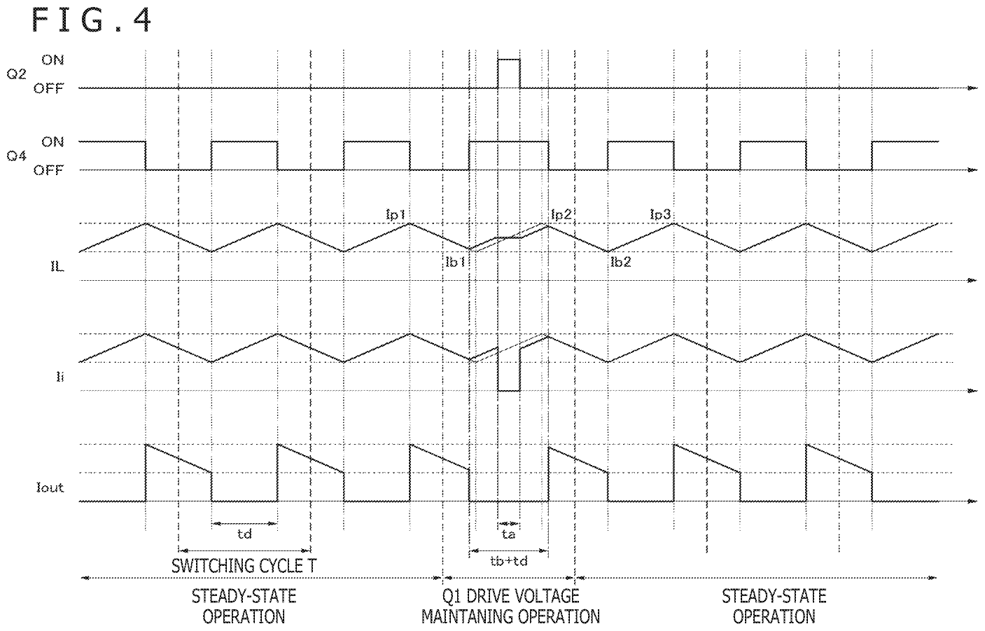

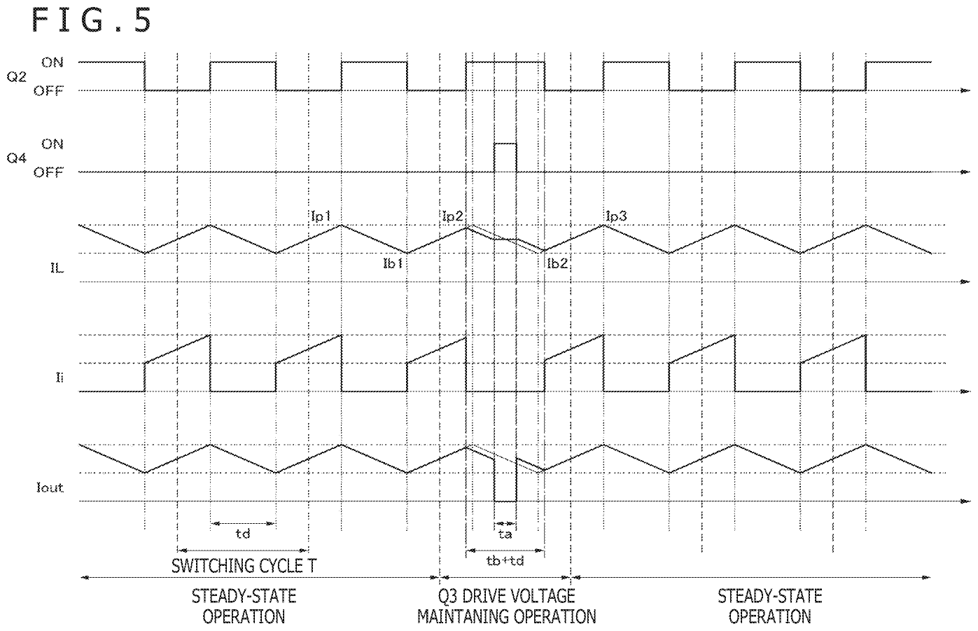

However, when the general bootstrap operation is performed in the power supply circuit 1, the output is fluctuated. This point is described with reference to timing charts of FIG. 2 and FIG. 3. Incidentally, although FIG. 2 and FIG. 3 depict timings at which the MOSFETs Q2 and Q4 are turned ON/OFF, the turn-ON/OFF of the MOSFET Q1 becomes reverse to the turn-ON/OFF of the MOSFET Q2, and the turn-ON/OFF of the MOSFET Q3 becomes reverse to the turn-ON/OFF of the MOSFET Q4. In addition, the switching duty of each of the MOSFET Q3 and the MOSFET Q4 is merely an example, and is set to 50% in this example. In addition, IL in FIG. 2 and FIG. 3 is a waveform of a current caused to flow through the inductor L1, Ii depicts a waveform of the input current, and lout depicts a waveform of an output current. This also applies to FIG. 4 and FIG. 5 which will be described later.

FIG. 2 is a timing chart depicting timings or the like at which in the step-up operation, the MOSFETs Q2 and Q4 are turned ON/OFF. As depicted in the figure, in a state in which the MOSFET Q1 is turned ON, in other words, the MOSFET Q2 is turned OFF on the basis of the switching cycle T responding to a predetermined switching frequency (e.g., 50 to 100 kHz), the switching operations of the MOSFETs Q3 and Q4 are performed, thereby performing a steady-state operation (in this example, a step-up operation).

Then, a period of time corresponding to a certain switching cycle T is allocated as an operation period of time for which a drive voltage of the MOSFET Q1 is maintained, that is, as a period of time for the bootstrap operation (hereinafter, referred to as a bootstrap operation period of time). As an example, although one bootstrap operation period of time is allocated to 100 times of switching cycles, the frequency by which the bootstrap operation is performed is suitably set in response to the capacitance of the capacitor C2.

When in the bootstrap operation period of time, the MOSFET Q2 is turned ON and the MOSFET Q4 is also turned ON, a current path of a closed loop: the MOSFET Q2→the inductor L1→the MOSFET Q4→the MOSFET Q2 is formed. At this time, the current IL caused to flow the inductor L1 becomes substantially constant. Since a period of time for which by the bootstrap operation, the current IL becomes substantially constant occurs, the current IL after the bootstrap operation is reduced all the more, and this state continues. In FIG. 2, the ideal current IL or the like after the MOSFET Q2 has been turned ON is indicated by a thin solid line, and the actual current IL is indicated by a solid line. Needless to say, the control unit 2 detects the output voltage Vout, and changes the switching duty of the MOSFETs Q3 and Q4 (e.g., determined by the duty ratio of the MOSFET Q3) on the basis of the detection result. Therefore, after several times of switching cycles, the reduction of the output is improved. However, as described above, right after the bootstrap operation, the reduction of the output is observed.

FIG. 3 is a timing chart depicting timings or the like at which in the step-down operation, the MOSFETs Q2 and Q4 are turned ON/OFF. As depicted in the figure, in a state in which the MOSFET Q3 is turned ON, in other words, the MOSFET Q4 is turned OFF on the basis of the switching cycle T responding to a predetermined switching frequency, the switching operations of the MOSFETs Q1 and Q2 are performed, thereby performing a steady-state operation (in this example, a step-down operation).

Then, similarly to the case of the step-up operation, a period of time corresponding to a certain switching cycle T is allocated as the operation period of time for which a drive voltage of the MOSFET Q3 is maintained, that is, as the bootstrap operation period of time.

When in the bootstrap operation period of time, the MOSFET Q4 is turned ON and the MOSFET Q2 is also turned ON, the current path of the closed loop: the MOSFET Q2→the inductor L1→the MOSFET Q4→the MOSFET Q2 is formed. At this time, the current IL caused to flow through the inductor L1 becomes substantially constant. Since a period of time for which by the bootstrap operation, the current IL becomes substantially constant occurs, the current IL after the bootstrap operation is not reduced to an ideal value all the more. As a result, the current IL increases so as to exceed the ideal value, and this state continues. In FIG. 3, the ideal current IL or the like after the MOSFET Q4 has been turned ON is indicated by a thin solid line, and the actual current IL is indicated by a solid line. Since whenever the bootstrap operation for maintaining the drive power of the MOSFET Q1 or the MOSFET Q3 is performed in such a manner, the output is fluctuated, the stability of the output from the power supply circuit 1 is reduced.

### Bootstrap Operation Pertaining to the Embodiment

The bootstrap operation pertaining to the embodiment is described on the basis of the point described above with reference to FIG. 4 and FIG. 5. Similarly to the case of FIG. 2, FIG. 4 is a timing chart depicting the timings or the like at which in the step-up operation, the MOSFETs Q2 and Q4 are turned ON/OFF. As depicted in the figure, in a state in which the MOSFET Q1 is turned ON, in other words, the MOSFET Q2 is turned OFF on the basis of a switching cycle T (first period of time) corresponding to the predetermined switching frequency, the switching operations of the MOSFETs Q3 and Q4 are performed, thereby performing the steady-state operation (in this example, the step-up operation). Here, a period of time for which the MOSFET Q4 in the steady-state operation is turned ON is referred as td.

Then, a period of time corresponding to a certain switching cycle T is allocated as the operation period of time for which the drive voltage of the MOSFET Q1 is maintained, that is, as the bootstrap operation period of time (second period of time). In this embodiment, the switching cycle T and the bootstrap operation period of time are set to the same length. As a result, although the processing can be efficiently executed, the switching cycle T and the bootstrap operation period of time may be different in length from each other. At a predetermined timing in the bootstrap operation period of time, both the MOSFETs Q2 and Q4 are turned ON. A period of time for which in the bootstrap operation period of time, the MOSFET Q2 is turned ON is referred as ta.

In the embodiment, the switching duty on the side of the MOSFETs Q3 and Q4 in the bootstrap operation period of time (e.g., the duty ratio of the MOSFET Q4) is more largely corrected than that in the steady-state. Specifically, as depicted in FIG. 4, a period of time for which in the bootstrap operation period of time, the MOSFET Q4 is turned ON is set to (tb+td), and thus is set longer than a period td of time for which in the switching cycle T, the MOSFET Q4 is turned ON. This control, for example, is performed by the half-bridge driver IC2 in accordance with the control by the control unit 2. As a result, as depicted in FIG. 4, while, for example, the period of time for which the current IL is reduced is shortened, the period of time for which the current IL is increased can be lengthened. Therefore, the current IL when the MOSFET Q3 is turned ON can be made the same as the current IL in the switching cycle T. Therefore, even in the case where there is a period of time for which the current IL becomes substantially constant (a period of time corresponding to the period of time for which both the MOSFETs Q2 and Q4 are turned ON), the output current lout can be kept the same before and after the bootstrap operation. As a result, the stability of the power supply circuit 1 can be enhanced.

Similarly to the case of FIG. 3, FIG. 5 is a timing chart depicting the timings or the like at which in the step-down operation, the MOSFETs Q2 and Q4 are turned ON/OFF. As depicted in the figure, in a state in which the MOSFET Q3 is turned ON, in other words, the MOSFET Q4 is turned OFF on the basis of a switching cycle T (first period of time) corresponding to the predetermined switching frequency, the switching operations of the MOSFETs Q1 and Q2 are performed, thereby performing the steady-state operation (in this example, the step-down operation). Here, a period of time for which the MOSFET Q2 in the steady-state operation is turned ON is referred as td.

Then, a period of time corresponding to a certain switching cycle T is allocated as the operation period of time for which the drive voltage of the MOSFET Q3 is maintained, that is, as the bootstrap operation period of time (second period of time). Both the MOSFETs Q2 and Q4 are turned ON at a predetermined timing in the bootstrap operation period of time. A period of time for which the MOSFET Q4 is turned ON in the bootstrap operation period of time is referred as ta.

In the embodiment, the switching duty on the side of the MOSFETs Q1 and Q2 in the bootstrap operation period of time (e.g., the duty ratio of the MOSFET Q2) is corrected more largely than that in the steady-state. Specifically, as depicted in FIG. 5, a period of time for which in the bootstrap operation period of time, the MOSFET Q2 is turned ON is set to (tb+td), and thus is set longer than a period td of time for which in the switching cycle T, the MOSFET Q2 is turned ON. This control, for example, is performed by the half-bridge driver IC1 in accordance with the control by the control unit 2. As a result, as depicted in FIG. 5, while, for example, the period of time for which the current IL is increased is shortened, the period of time for which the current IL is reduced can be lengthened. Therefore, the current IL when the MOSFET Q1 is turned ON can be made the same to the current IL in the switching cycle T. Therefore, even in the case where there is a period of time for which the current IL becomes substantially constant (a period of time corresponding to the period of time for which both the MOSFETs Q2 and Q4 are turned ON), the output current lout can be kept the same before and after the bootstrap operation. As a result, the stability of the power supply circuit 1 can be enhanced.

### [Example of Method of Calculating Correction Period of Time]

The correction period of time (tb described above) pertaining to the embodiment can be calculated with the fact that the output current becomes the same before and after the bootstrap operation as a condition on the basis of the switching duty at the time of the steady-state operation, and the switching duty at the time of the bootstrap operation. Processing of calculating tb as the correction period of time, for example, is performed by the control unit 2. Hereinafter, a description will be given with respect to an example of a method of calculating tb at the time of the step-up operation. It should be noted that the contents represented by characters in Equations are as follows (refer to FIG. 4).
the switching cycle: T
the period of time for which the MOSFET Q2 is turned ON: ta
the time for which the MOSFET Q4 is turned ON in the period of time of the steady-state operation (switching cycle): td
the correction amount of the time for which the MOSFET Q4 is turned ON: tb
an input voltage: Vᵢ
an output voltage: Vₒ
the inductance of the inductor L1: L
the current caused to flow through the inductor L1: IL
peaks of IL in a period of time for the steady-state operation (switching cycle): I_{P1} and I_{P3}
a peak of IL in the bootstrap operation period of time: Iₚ₂
a bottom of IL in a period of time for the steady-state operation (switching cycle): I_{b1}
a peak of IL in the bootstrap operation period of time: I_{b2}

The currents I_{b1}, I_{P2}, I_{b2}, and I_{P3} can be expressed by following Equations 1 to 4, respectively.

$$\begin{matrix}[ Math . 1 ] & \\ {I}_{b 1} = {I}_{p 1} - \frac{{V}_{O} - {V}_{i}}{L} ( T - {t}_{d} - \frac{{t}_{p}}{2} ) \\ [ Math . 2 ] & ( 1 ) \\ {I}_{p 2} = {I}_{b 1} - \frac{{V}_{i}}{L} ( {t}_{d} + {t}_{b} - {t}_{a} ) \\ [ Math . 3 ] & ( 2 ) \\ {I}_{b 2} = {I}_{p 2} - \frac{{V}_{O} - {V}_{i}}{L} ( T - {t}_{d} - \frac{{t}_{p}}{2} ) \\ [ Math . 4 ] & ( 3 ) \\ {I}_{p 3} = {I}_{ b 2} + \frac{{V}_{i}}{L} {t}_{d} & ( 4 )\end{matrix}$$

Here, when Equations 1 to 4 are solved on the assumption of a relationship of I_{P1}=I_{P3} holds, following Equation 5 is obtained.

$$\begin{matrix}[ Math . 5 ] & \\ {t}_{b} = 2 T - 2 {t}_{d} - \frac{{V}_{i}}{{V}_{o}} ( 2 T - {t}_{a} ) & ( 5 )\end{matrix}$$

Here, since Vₒ/Vᵢ is the step-up ratio of the output voltage to the input voltage, the step-up ratio of interest can be expressed by following Equation 6.

$$\begin{matrix}[ Math . 6 ] & \\ \frac{{V}_{O}}{{V}_{i}} = \frac{1}{1 - \frac{{t}_{d}}{T}} & ( 6 )\end{matrix}$$

By substituting Equation 6 for Equation 5, tb as the correction period of time can be calculated from following Equation 7.

$$\begin{matrix}[ Math . 7 ] & \\ {t}_{b} = {t}_{a} ( 1 - \frac{{t}_{d}}{T} ) & ( 7 )\end{matrix}$$

Next, a description will be given with respect to an example of a method of calculating tb at the time of the step-down operation. It should be noted that the contents represented by characters in Equations are as follows (refer to FIG. 5).
the switching cycle: T
the period of time for which the MOSFET Q4 is turned ON: ta
the time for which the MOSFET Q2 is turned ON in the period of time of the steady-state operation (switching cycle): td
the correction amount of the time for which the MOSFET Q2 is turned ON: tb
an input voltage: Vᵢ
an output voltage: Vₒ
the inductance of the inductor L1: L
the current caused to flow through the inductor L1: IL
peaks of IL in a period of time for the steady-state operation (switching cycle): I_{P1} and I_{P3}
a peak of IL in the bootstrap operation period of time: I_{P2}
a bottom of IL in a period of time for the steady-state operation (switching cycle): I_{b1}
a peak of IL in the bootstrap operation period of time: I_{b2}

The currents I_{b1}, I_{P2}, I_{b2}, and I_{P3} can be expressed by following Equations 8 to 11, respectively.

$$\begin{matrix}[ Math . 8 ] & \\ {I}_{b 1} = {I}_{p 1} - \frac{{V}_{O}}{L} {t}_{d} \\ [ Math . 9 ] & ( 8 ) \\ {I}_{p 2} = {I}_{b 1} + \frac{{V}_{i} - {V}_{O}}{L} ( T - {t}_{d} - \frac{{t}_{p}}{2} ) \\ [ Math . 10 ] & ( 9 ) \\ {I}_{b 2} = {I}_{p 2} - \frac{{V}_{O}}{L} ( {t}_{d} + {t}_{b} - {t}_{a} ) \\ [ Math . 11 ] & ( 10 ) \\ {I}_{p 3} = {I}_{b 2} + \frac{{V}_{i} - {V}_{O}}{L} ( T - {t}_{d} - \frac{{t}_{p}}{2} ) & ( 11 )\end{matrix}$$

Here, when Equations 8 to 11 are solved on the assumption of a relationship of I_{P1}=I_{P3} holds, following Equation 12 is obtained.

$$\begin{matrix}[ Math . 12 ] & \\ {t}_{b} = 2 T - 2 {t}_{d} - \frac{{V}_{O}}{{V}_{i}} ( 2 T - {t}_{a} ) & ( 12 )\end{matrix}$$

Here, since Vₒ/Vᵢ is the step-down ratio of the output voltage to the input voltage, the step-down ratio of interest can be expressed by following Equation 13.

$$\begin{matrix}[ Math . 13 ] & \\ \frac{{V}_{O}}{{V}_{i}} = 1 - \frac{{t}_{d}}{T} & ( 13 )\end{matrix}$$

By substituting Equation 12 for Equation 13, tb as the correction period of time can be calculated from following Equation 14.

$$\begin{matrix}[ Math . 14 ] & \\ {t}_{b} = {t}_{a} ( 1 - \frac{{t}_{d}}{T} ) & ( 14 )\end{matrix}$$

The embodiment of the present disclosure has been described so far. According to the power supply circuit according to the embodiment, the fluctuation of the output which can be generated with the bootstrap operation can be suppressed.

### 2. MODIFIED EXAMPLES

Although the embodiment of the present disclosure has been concretely described so far, the contents of the present disclosure are by no means limited to the embodiment described above, and various kinds of modifications based on the technical idea of the present disclosure can be made.

In the embodiment described above, the bootstrap operation is performed only in one switching cycle. However, the bootstrap operation may be performed over a plurality of switching cycles.

In the embodiment described above, tb as the correction period of time to be added to td may be added temporally to the back side of the period td of time, may be added to the front side of the period td of time, or tb/2 may be added to each of the back side and front side of the period td of time.

Another element such as an IGBT (Insulated Gate Bipolar Transistor) may be used as the switching element.

The configuration, the method, the process, the shape, the material, and the numerical values, and the like which are given in the embodiment described above are merely an example, and a configuration, a method, a process, a shape, a material, numerical values, and the like which are different from those in the embodiment may be included if necessary. In addition, the matters described in the embodiment and the modified examples can be combined with each other as long as the technical contradiction is caused.

It should be noted that the present disclosure can also adopt the following configurations.
(1)

A power supply circuit including:

a switching element pair having a high-side switching element, and a low-side switching element connected in series with the high-side switching element; and

a control section complementarily driving the respective switching elements configuring the switching element pair,

in which the control section controls ON/OFF of the respective switching elements in such a way that a switching duty of the high-side switching element and the low-side switching element in a first period of time, and a switching duty of the high-side switching element and the low-side switching element in a second period of time are different from each other.
(2)

The power supply circuit according to (1), in which the control section performs control so that a period of time for which the low-side switching element is turned ON in the second period of time is longer than a period of time for which the low-side switching element is turned ON in the first period of time.
(3)

The power supply circuit according to (1) or (2), in which the switching element pair has a first switching element pair having a high-side first switching element and a low-side second switching element, and a second switching element pair having a high-side third switching element and a low-side fourth switching element.
(4)

The power supply circuit according to (3), in which the control section complementarily drives the third switching element and the fourth switching element in a step-up operation stepping up an input voltage, and complementarily drives the first switching element and the second switching element in a step-down operation stepping down the input voltage.
(5)

The power supply circuit according to (4), further including:

a first bootstrap circuit generating a first drive signal whose voltage is stepped up to the input voltage or more in order to drive the first switching element; and

a second bootstrap circuit generating a second drive signal whose voltage is stepped up to the input voltage or more in order to drive the third switching element.
(6)

The power supply circuit according to (5), in which

the first bootstrap circuit has a first bootstrap capacitor,

the second bootstrap circuit has a second bootstrap capacitor, and

the second period of time is a period of time for which any of the first and second bootstrap capacitors is charged.
(7)

The power supply circuit according to any one of (3) to (6), in which the control section

complementarily drives the third switching element and the fourth switching element while the first switching element is turned ON in the first period of time,

drives the switching elements in such a way that the second switching element and the fourth switching element are both turned ON at a predetermined timing in the second period of time, and

performs control so that a period of time for which the fourth switching element is turned ON in the second period of time becomes longer than a period of time for which the fourth switching element is turned ON in the first period of time.
(8)

The power supply circuit according to any one of (3) to (6), in which the control section

complementarily drives the first switching element and the second switching element while the third switching element is turned ON in the first period of time,

drives the switching elements in such a way that the second switching element and the fourth switching element are both turned ON at a predetermined timing in the second period of time, and

performs control so that a period of time for which the second switching element is turned ON in the second period of time becomes longer than a period of time for which the second switching element is turned ON in the first period of time.
(9)

The power supply circuit according to any one of (1) to (8), in which the first period of time and the second period of time have the same length corresponding to a switching cycle.
(10)

The power supply circuit according to any one of (3) to (8), in which a connection midpoint between the first switching element and the second switching element, and a connection midpoint between the third switching element and the fourth switching element are connected to each other via an inductor.
(11)

The power supply circuit according to any one of (1) to (10), in which the switching element includes an N-channel MOSFET.
(12)

The power supply circuit according to any one of (1) to (11), in which the power supply circuit is a bi-directional circuit operating even in a case where an input side and an output side are reversed.
(13)

The power supply circuit according to any one of (1) to (12), in which the control section calculates periods of time for which the respective switching elements are turned ON/OFF by a digital arithmetic operation.
(14)

An electric vehicle including:

a conversion device receiving supply of a power from a power supply system including the power supply circuit according to any one of (1) to (13), and converting the power into a driving force of a vehicle; and

a controller executing information processing associated with vehicle control on a basis of information associated with a power storage device.

### 3. APPLICATION EXAMPLES

The technology pertaining to the present disclosure can be applied to various products. For example, the present disclosure can be realized as a power supply apparatus having the power supply circuit according to the embodiment described above, or a battery unit controlled by the power supply circuit. Moreover, such a power supply apparatus may be realized as an apparatus mounted to any kind of moving body of an automobile, an electric car, a hybrid electric car, a motor cycle, a bicycle, a personal mobility, an airplane, a drone, a ship, a robot, a construction machine, an agricultural machine (tractor), and the like. Hereinafter, although concrete application examples will be described, the contents of the present disclosure are by no means limited to the application examples which will be described below.

### “Power Storage System in Vehicle as Application Example”

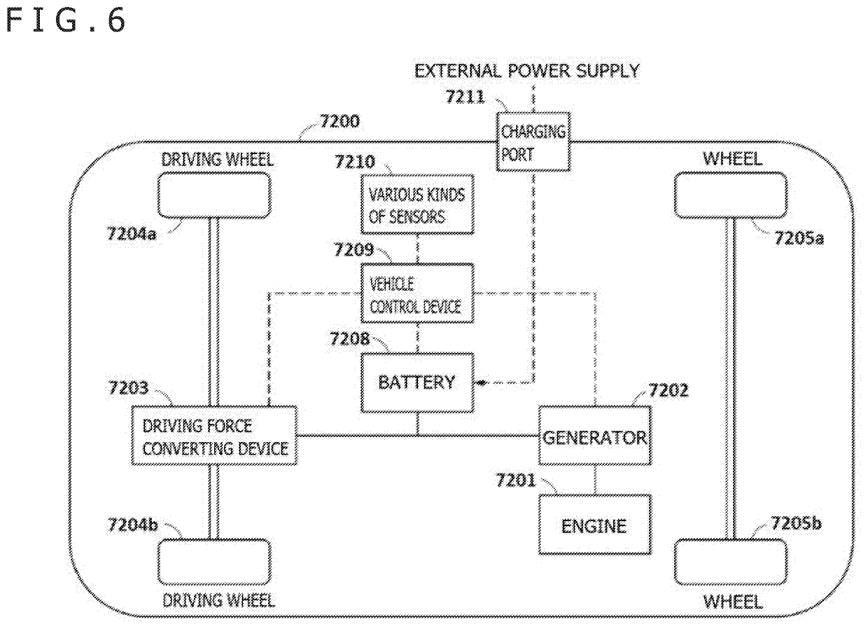

A description will be given with respect to an example in which the present disclosure is applied to a power storage system for a vehicle with reference to FIG. 6. FIG. 6 schematically depicts an example of a configuration of a hybrid vehicle adopting a series hybrid system to which the present disclosure is applied. The series hybrid system is a vehicle which is run by a driving force converting device by using a power generated by a generator moved by an engine, or a power obtained by temporarily storing the generated power in a battery.

This hybrid vehicle 7200 includes an engine 7201, a generator 7202, a power to driving force converting device 7203, a driving wheel 7204a, a driving wheel 7204b, a wheel 7205a, a wheel 7205b, a battery 7208, a vehicle control device 7209, various kinds of sensors 7210, and a charging port 7211. The above-described power supply circuit according to an embodiment of the present disclosure is applied to a control circuit of the battery 7208 and a circuit of the vehicle control device 7209.

The hybrid vehicle 7200 runs with the power to driving force converting device 7203 as a power source. An example of the power to driving force converting device 7203 is a motor. The power to driving force converting device 7203 is activated by the power of the battery 7208. A rotational force of the power to driving force converting device 7203 is transmitted to the driving wheels 7204a and 7204b. Incidentally, the power to driving force converting device 7203 is applicable both as an alternating-current motor and as a direct-current motor by using direct current to alternating current conversion (DC-to-AC conversion) or reverse conversion (AC-to-DC conversion) at a necessary position. The various kinds of sensors 7210 control engine speed via the vehicle control device 7209, and control a degree of opening (degree of throttle opening) of a throttle valve not depicted in the figure. The various kinds of sensors 7210 include a speed sensor, an acceleration sensor, an engine speed sensor, and the like.

A rotational force of the engine 7201 is transmitted to the generator 7202. Power generated by the generator 7202 by the rotational force can be stored in the battery 7208.

When the hybrid vehicle is decelerated by a braking mechanism not depicted in the figure, a resistance force at the time of the deceleration is applied as a rotational force to the power to driving force converting device 7203. Regenerative power generated by the power to driving force converting device 7203 by the rotational force is stored in the battery 7208.

The battery 7208 can also be connected to a power supply external to the hybrid vehicle to be supplied with power from the external power supply with the charging port 7211 as an input port, and store the received power.

Though not depicted, an information processing device may be provided which performs information processing related to vehicle control on the basis of information about the secondary battery. As such an information processing device, there is, for example, an information processing device that makes battery remaining charge amount display on the basis of information about an amount of charge remaining in the battery.

The above description has been made by taking, as an example, a series hybrid vehicle run by a motor using power generated by a generator driven by an engine or power supplied from a battery that stores the power generated by the generator. However, the present disclosure is effectively applicable also to a parallel hybrid vehicle that uses both of outputs of an engine and a motor as driving sources and which appropriately selects and uses three systems, that is, a system in which the vehicle is run by only the engine, a system in which the vehicle is run by only the motor, and a system in which the vehicle is run by the engine and the motor. Further, the present disclosure is effectively applicable also to an electric vehicle run by being driven by only a driving motor without the use of an engine.

The description has been given with respect to the example of the hybrid vehicle 7200 to which the technology pertaining to the present disclosure can be applied so far. The power supply circuit according to the embodiment of the present disclosure, for example, can be applied as a circuit associated with an input and an output to and from the battery 7208.

### “Power Storage System in House as Application Example”

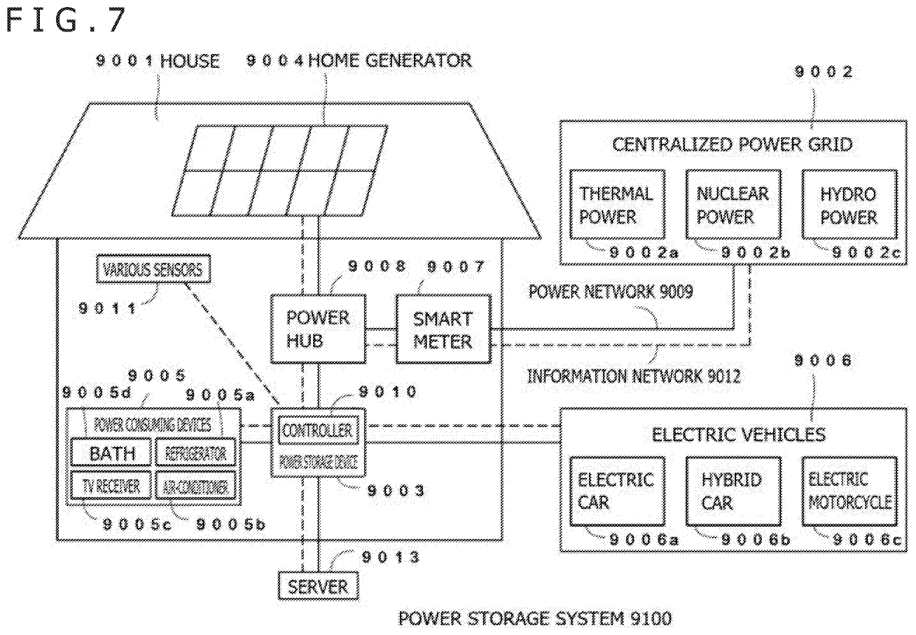

A description will be given with respect to an example in which the present disclosure is applied to a power storage system for a house with reference to FIG. 7. For example, in a power storage system 9100 for a house 9001, the power is supplied from a centralized power grid 9002 such as thermal power generation 9002a, nuclear power generation 9002b, hydro power generation 9002c and the like to a power storage device 9003 via a power network 9009, an information network 9012, a smart meter 9007, a power hub 9008, and the like. Together with this supply of the power, the power is supplied from an independent power supply such as a home generator 9004 to the power storage device 9003. The power supplied to the power storage device 9003 is saved. The power to be used in the house 9001 is fed by using the power storage device 9003. With respect to not only the house 9001, but also a building, the similar power storage system can be used.

The house 9001 is equipped with the generator 9004, power consuming devices 9005, the power storage device 9003, a controller 9010 for controlling these various devices, the smart meter 9007, and sensors 9011 for acquiring various information. These devices are connected by the power network 9009 and the information network 9012. A solar or fuel cell, for example, is used as the generator 9004. Generated electric power is supplied to the power consuming devices 9005 and/or the power storage device 9003. The power consuming devices 9005 are a refrigerator 9005a, an air-conditioner 9005b, a television (TV) receiver 9005c, a bath 9005d, and so on. The power consuming devices 9005 further include electric vehicles 9006. The electric vehicles 9006 are an electric car 9006a, a hybrid car 9006b, and an electric motorcycle 9006c.

A battery unit of the present disclosure described above is used for a circuit applied to the power storage device 9003. The power storage device 9003 includes a secondary battery or capacitor. For example, the power storage device 9003 includes a lithium ion battery. The lithium ion battery may be a stationary one or one designed for the electric vehicles 9006. The smart meter 9007 is capable of measuring commercial power consumption and sending the measured consumption to an electric power company. The power network 9009 may include any one or a plurality of direct current (DC), alternating current (AC), and non-contact power supplies.

The various sensors 9011 are, for example, human, illuminance, object detection, power consumption, vibration, contact, temperature, infrared, and other sensors. Information acquired by the various sensors 9011 is sent to the controller 9010. Information from the sensors 9011 makes it possible to find out about meteorological, human, and other conditions, so as to automatically control the power consuming devices 9005 and reduce energy consumption to minimum. Further, the controller 9010 can send information on the house 9001, for example, to an external electric power company via the Internet.

The power hub 9008 handles the division of a power line into branches, DC/AC conversion, and other tasks. Communication schemes used between the controller 9010 and the information network 9012 connected thereto are the one using communication interfaces such as universal asynchronous receiver-transmitter (UART) and the one using sensor networks based on wireless communication standards such as Bluetooth, ZigBee, and wireless fidelity (Wi-Fi). Bluetooth scheme is applied to multimedia communication to permit one-to-many communication. ZigBee uses the physical layer of institute of electrical and electronic engineers (IEEE) 802.15.4. IEEE 802.15.4 is the name of a short-distance wireless network standard that is referred to as personal area network (PAN) or wireless (W) PAN.

The controller 9010 is connected to an external server 9013. The external server 9013 may be managed by any of the house 9001, an electric power company, or a service provider. Information sent and received by the server 9013 is, for example, power consumption information, life pattern information, power rate information, weather information, natural disaster information, and information on electricity trading. These pieces of information may be sent to and received from a power consuming device (e.g., TV receiver) in the home. Alternatively, they may be sent to and received from a device outside of the home (e.g., mobile phone). These pieces of information may be shown on an appliance with a display function such as TV receiver, mobile phone, or personal digital assistant (PDA).

The controller 9010 that controls each of these sections includes, for example, a central processing unit (CPU), a random access memory (RAM), and a read only memory (ROM). In the present example, the controller 9010 is accommodated in the power storage device 9003. The controller 9010 is connected to the power storage device 9003, the home generator 9004, the power consuming devices 9005, the various sensors 9011, and the server 9013 via the information network 9012. The controller 9010 is capable, for example, of regulating commercial power consumption and power output. It should be noted that the controller 9010 may additionally be capable of trading electricity in electricity markets.

As described above, not only electric power from the centralized power grid 9002 including the thermal power 9002a, the nuclear power 9002b, the hydro power 9002c and the like but also that generated by the home generator 9004 (solar and wind power) can be stored in the power storage device 9003. Therefore, it is possible to perform control including, for example, maintaining the externally supplied power constant or discharging the power storage device 9003 as much as possible needed even in the event of a change in power generated by the home generator 9004. For example, it is possible to store electric power obtained from solar power generation and inexpensive midnight power with low night rates in the power storage device 9003, and discharge and use the power stored in the power storage device 9003 in daytime hours with high rates.

It should be noted that although a case has been described in the present example in which the controller 9010 is accommodated in the power storage device 9003, the controller 9010 may be accommodated in the smart meter 9007. Alternatively, the controller 9010 may be a standalone unit. Still alternatively, the power storage system 9100 may be used for a plurality of households in a housing complex. Still alternatively, the power storage system 9100 may be used for a plurality of detached houses.

The description has been given with respect to the example of the power storage system 9100 to which the technology pertaining to the present disclosure can be applied so far. The technology pertaining to the present disclosure, of the configurations described so far, can be suitably applied to the power storage device 9003. Specifically, the power supply circuit according to the embodiment can be applied to the circuit associated with the power storage device 9003.

### REFERENCE SIGNS LIST

1 . . . Power supply circuit
2 . . . Control unit
IC1, IC2 . . . Half-bridge driver
Q1 to Q4 . . . N-channel MOSFET
L1 . . . Inductor
C2, C4 . . . (Bootstrap) capacitor
D1, D2 . . . Diode

1. A power supply circuit comprising:
a switching element pair having a high-side switching element, and a low-side switching element connected in series with the high-side switching element; and
a control section complementarily driving the respective switching elements configuring the switching element pair,
wherein the control section controls ON/OFF of the respective switching elements in such a way that a switching duty of the high-side switching element and the low-side switching element in a first period of time, and a switching duty of the high-side switching element and the low-side switching element in a second period of time are different from each other.

2. The power supply circuit according to claim 1, wherein the control section performs control so that a period of time for which the low-side switching element is turned ON in the second period of time is longer than a period of time for which the low-side switching element is turned ON in the first period of time.

3. The power supply circuit according to claim 1, wherein the switching element pair has a first switching element pair having a high-side first switching element and a low-side second switching element, and a second switching element pair having a high-side third switching element and a low-side fourth switching element.

4. The power supply circuit according to claim 3, wherein the control section complementarily drives the third switching element and the fourth switching element in a step-up operation stepping up an input voltage, and complementarily drives the first switching element and the second switching element in a step-down operation stepping down the input voltage.

5. The power supply circuit according to claim 4, further comprising:
a first bootstrap circuit generating a first drive signal whose voltage is stepped up to the input voltage or more in order to drive the first switching element; and
a second bootstrap circuit generating a second drive signal whose voltage is stepped up to the input voltage or more in order to drive the third switching element.

6. The power supply circuit according to claim 5, wherein
the first bootstrap circuit has a first bootstrap capacitor,
the second bootstrap circuit has a second bootstrap capacitor, and
the second period of time is a period of time for which any of the first and second bootstrap capacitors is charged.

7. The power supply circuit according to claim 3, wherein the control section
complementarily drives the third switching element and the fourth switching element while the first switching element is turned ON in the first period of time,
drives the switching elements in such a way that the second switching element and the fourth switching element are both turned ON at a predetermined timing in the second period of time, and
performs control so that a period of time for which the fourth switching element is turned ON in the second period of time becomes longer than a period of time for which the fourth switching element is turned ON in the first period of time.

8. The power supply circuit according to claim 3, wherein the control section
complementarily drives the first switching element and the second switching element while the third switching element is turned ON in the first period of time,
drives the switching elements in such a way that the second switching element and the fourth switching element are both turned ON at a predetermined timing in the second period of time, and
performs control so that a period of time for which the second switching element is turned ON in the second period of time becomes longer than a period of time for which the second switching element is turned ON in the first period of time.

9. The power supply circuit according to claim 1, wherein the first period of time and the second period of time have the same length corresponding to a switching cycle.

10. The power supply circuit according to claim 3, wherein a connection midpoint between the first switching element and the second switching element, and a connection midpoint between the third switching element and the fourth switching element are connected to each other via an inductor.

11. The power supply circuit according to claim 1, wherein the switching element includes an N-channel MOSFET.

12. The power supply circuit according to claim 1, wherein the power supply circuit is a bi-directional circuit operating even in a case where an input side and an output side are reversed.

13. The power supply circuit according to claim 1, wherein the control section calculates periods of time for which the respective switching elements are turned ON/OFF by a digital arithmetic operation.

14. An electric vehicle comprising:
a conversion device receiving supply of a power from a power supply system including the power supply circuit according to claim 1, and converting the power into a driving force of a vehicle; and
a controller executing information processing related to vehicle control on a basis of information associated with a power storage device.
